(19) United States
(12) Patent Application Publication
(10) Pub. No.: US 2025/0022301 A1
(43) Pub. Date: Jan. 16, 2025

(54) JOINT TEXT SPOTTING AND LAYOUT ANALYSIS

(71) Applicant: Google LLC, Mountain View, CA (US)

(72) Inventors: Shangbang Long, Sunnyvale, CA (US); Siyang Qin, Danville, CA (US); Yasuhisa Fujii, Sunnyvale, CA (US); Alessandro Bissacco, Los Angeles, CA (US); Michail Raptis, Venice, CA (US)

(21) Appl. No.: 18/772,414

(22) Filed: Jul. 15, 2024

(30) Foreign Application Priority Data
Jul. 13, 2023 (GR) 20230100574

(51) Int. Cl. G06V 30/20; G06V 30/14; G06V 30/166; G06V 30/18; G06V 30/19

(52) U.S. Cl. CPC G06V 30/20; G06V 30/1448; G06V 30/166; G06V 30/18; G06V 30/19107; G06V 30/19173

(57) ABSTRACT

Methods, systems, and apparatus, including computer programs encoded on a computer storage medium, for detecting text instances of arbitrary shapes, sizes, and locations. In one aspect, a method comprises processing an image depicting one or more text instances, generating a respective prediction for each character in a sequence of characters that are predicted to be depicted in the text instance, the respective prediction comprising a respective character class to which the predicted character belongs, the respective character class selected from a set that includes printable character classes and a space character class and a bounding box that contains the character within the image, and grouping the sequence of characters into a plurality of words based on locations of characters that are predicted to belong to the space character class.

### CLAIM OF PRIORITY

This application claims priority under 35 USC § 119 (a) to Greek Patent Application No. 20230100574, filed in the Greek Patent Office on Jul. 13, 2023, the entire contents of which are hereby incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

This specification also relates to text detection. Within the context of text detection, a bounding box is a box that encloses a detected text entity, e.g., a word or character. Axis-aligned bounding boxes are bounding boxes with coordinates defined on the x- and y-axes of an image.

### SUMMARY

This specification generally describes a system implemented as computer programs on one or more computers in one or more locations that can process an image depicting one or more text instances—objects of various shapes, sizes, and locations containing text—to detect text entities, e.g., paragraph, word, text line, and character-level entities, within each text instance within the image.

In particular, this specification describes a variety of techniques that can be used consolidate the tasks of text detection and geometric layout analysis in a machine learning model. More specifically, the system can implement a unified machine learning model that has been trained to perform a joint text detection and geometric layout analysis task for images depicting one or more text instances. In this context, geometric layout detection refers to detecting visually and geometrically coherent text blocks as text instance objects, e.g., by predicting the coordinates of a polygon text boundary that encompasses the text instance object.

In particular, the system can generate a hierarchical text representation of the detected text instance. In this specification, generating a hierarchical text representation refers to populating a machine-readable text format output with two or more of the paragraph, word, text line, and character-level entities detected for each text instance within the image. As an example, the hierarchical representation can be a structured multi-level dictionary. Additionally, the system can generate one or more of paragraph, word, text line, and character-level layout masks that correspond to the detected text entities of the text instance and overlay the masks on the original image to visualize the hierarchical text representation.

In an example method, the system receives an image depicting a text instance and processes the image to generate an encoded text representation. The encoded text representation can be further processed to generate a character prediction and a respective bounding box for each of the characters in the sequence of characters in the text instance.

In some examples, the image is encoded with an image encoder neural network and the generated characters and their respective bounding boxes are predicted by a character recognition neural network. In particular, the character recognition neural network can include an encoder to encode the characters in the text representation into a contextualized encoded sequence, and a decoder that, for each character, processes the contextualized encoded sequence and the predictions for the preceding sequence characters to generate a hidden representation feature for each character, which can be further processed by a character prediction neural network and a bounding box neural network to generate a predicted character class and a number of bounding box coordinates for each character, respectively.

In this case, word-level entities can be generated from the character recognition neural network output by grouping one or more printable characters based on locations of nonprintable, e.g., space characters. Additionally, in some examples, combining the distance between the respective bounding boxes of each character that is grouped into a word with the space characters generates the coordinates of a word bounding box.

In some cases, the image depicting a text instance is generated by preprocessing an original image with one or more transformations from an original input image space to a text instance space. Potential transformations include cropping a portion of the original image that corresponds with the location of the text instance region, rectifying the text instance if curved, applying a grayscale, or processing the original image with a convolutional neural network to generate a reduced-dimension image. In particular, the original image can be cropped and rectified using a bilinear interpolation mapping algorithm, such as BezierAlign. After processing by the character recognition neural network, the one or more characters and words predicted in the text instance space can be scaled back into the original image space by normalizing by text instance height and projecting using the inverse of the bilinear interpolation mapping, if the bilinear interpolation is applied in the transformation.

In an example application, the image encoder and the character recognition neural network have been trained using supervision with an additional character localization loss for a subset of the training data set for which ground-truth bounding box annotations are available.

In another example method, the system processes an image depicting one or more text instances and a series of input object queries that specify different regions of the image to generate a set of encoded object queries, where each encoded object query includes a learnable embedding corresponding to each text instance in the original image. The encoded object queries can be further processed to detect a polygon text boundary around each text instance defined by one or more coordinates that correspond with an axis-aligned bounding box for each text instance. In certain examples, the system may parametrize the polygon as a set of Bezier curve polygons. In particular, the system may generate 4 (m+1) control point coordinates corresponding to two Bezier polylines of order m that form the polygon text boundary.

In some examples, the image and the input object queries are encoded with a feature extractor neural network and a polygon detector prediction neural network processes the encoded object queries to detect a polygon text boundary around each of the one or more text instances in the original image. In particular, the polygon detector prediction neural network can include a location head to predict a number of coordinates defining an axis-aligned bounding box for the location of the text instance in the original image space and a shape head that generates control points for a polygon within the axis-aligned bounding box as determined by the location head. In some cases, the polygon detector prediction neural network can also scale and translate the polygon defined by the control points in the axis-aligned bounding box back into the original image space.

In a further example, the polygon detector neural network can additionally include a layout head to generate a layout feature mask for each object query and a textness head to generate a classification score denoting the probability of each generated feature mask associated with each encoded object being a text instance. In some cases, computing an inner product of the generated feature masks from the layout head can generate an affinity matrix that defines a mapping between detected text lines and their respective paragraphs.

In some examples, the unified detector polygon neural network has been trained on a loss function including one or more losses that pertain to the location and shape of the detected text instance. For example, the loss function can include a text loss that characterizes the overlap of predicted text masks from the textness head with ground truth text masks in the original image space and a paragraph layout analysis loss that characterizes whether the affinity matrix generated by the layout head maps each text line entity to the correct paragraph. The loss function can also include predicted polygon coordinate losses, such as: an original image space polygon loss that characterizes the overlap of polygons predicted by the polygon prediction head with ground truth polygons in the original image space, an original image space location loss that characterizes the accuracy of the coordinates predicted by the location head that define the axis-aligned bounding boxes in the original image space, and an axis-aligned bounding box polygon loss that characterizes the accuracy of the polygon control points predicted by the shape head in the local axis-aligned bounding box space.

In another example described herein, a system comprises one or more computers; and one or more storage devices communicatively coupled to the one or more computers. The one or more storage devices store instructions that, when executed by the one or more computers, cause the one or more computers to perform the operations of any method described herein.

In another example described herein, one or more non-transitory computer storage media store instructions that when executed by one or more computers cause the one or more computers to perform the operations of any method described herein.

Particular embodiments of the subject matter described in this specification can be implemented so as to realize one or more of the following advantages.

The extraction and comprehension of text in images plays an important role in many computer vision applications. The system as specified can be used to generate a hierarchical text representation output for a variety of optical character recognition contexts, including standalone images depicting text instances, documents, and videos. In particular, the system can be especially useful for parsing documents with non-standard formats, such as tables and figures and images with complex nonlinear text layouts.

Generally, text detection methods are not proficient at detecting curved text, e.g., neither top-down nor bottom-up mask prediction methods can robustly identify curved text without fine-tuning on specific data, e.g., since both approaches involve detecting the geometric layout independently of text recognition. In contrast, the unified model of this specification is effective at jointly detecting geometric layout and text across images containing both straight, curved, sparse, and dense text instances without fine-tuning on specific data, thereby showcasing the unified model's robust generalization with respect to other approaches that require specialized models.

In an example model described in this specification, a character recognition neural network predicts characters and generates words by grouping predicted printable characters based on the location of predicted space characters; and a polygon detector prediction neural network predicts text-line instances and groups the text-line instances into paragraphs. In particular, the polygon detector prediction neural network can detect more accurate bounding boxes around the text-line instances by decoupling the prediction of bounding box location and shape. Additionally, separating the tasks of detecting polygon text boundaries and detecting the text in the polygon text boundaries ensures that the system does not suffer from the asynchronous convergence that can result from using feature maps for cropping and text recognition, e.g., in an end-to-end text spotter.

By training the model as described, the system can achieve state of the art performance on both text line detection and geometric layout analysis, e.g., on multiple word-level text spotting benchmark data sets. Importantly, these results are obtained with a single unified model, and without fine-tuning on target datasets, thereby ensuring that the proposed methods can support generic text extraction applications. More specifically, the system can enable the detection of text instances of arbitrary shapes, sizes, and locations, even when trained with only partially annotated image data, e.g., unlike sequence-to-sequence text recognizers that require fully annotated character bounding box data, which can be rare for real-image data sets.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a system diagram of an example joint text spotting and layout analysis system.

FIG. 2 is an example implementation of a unified detector polygon engine that can detect a polygon text boundary for text of any arbitrary orientation as part of a joint text spotting and layout analysis system, e.g., the system of FIG. 1.

FIG. 3 is an example implementation of a line-to-character-to-word recognizer engine that can detect characters and words as part of a joint text spotting and layout analysis system, e.g., the system of FIG. 1.

FIGS. 4A and 4B illustrate example results from the example joint text spotting and layout analysis system of FIG. 1.

FIG. 5 is a flow diagram of an example process for detecting word and character-level entities.

FIG. 6 is a flow diagram of an example process for detecting a polygon text boundary around a text instance.

Like reference numbers and designations in the various drawings indicate like elements.

### DETAILED DESCRIPTION

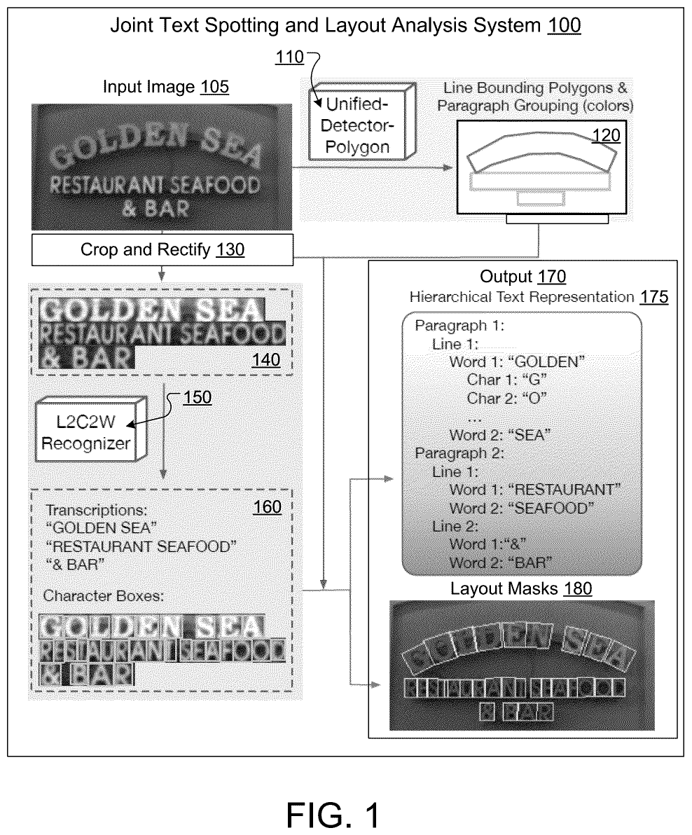

FIG. 1 shows an example joint text and geometric layout analysis system 100 that can simultaneously detect text and recognize the geometric relationship of detected text in an image. The joint text and geometric layout analysis system 100 is an example of a system implemented as computer programs on one or more computers in one or more locations in which the systems, components, and techniques described below are implemented.

In particular, the system 100 can extract a hierarchical text representation 175, e.g., a machine-readable text format output of one or more text entities in an image, from text instances of any arbitrary shape, size, and location in an input image. The system 100 can extract the hierarchical text representation using a unified detector polygon engine 110 and a line-to-character-to-word recognizer engine 150, as will be described in more detail below.

In particular, the system 100 can receive an input image 105, e.g., an original image with one or more text instances. As an example, the input image 105 can include printed text in a document, handwritten text, or text on signs and billboards. As another example, the input image 105 can include text in screenshots or from a digital display, text on product packaging, or text in a scene, e.g., graffiti. As yet another example, the input image 105 can include text overlaid on the image. In the particular example depicted, the input image 105 includes the text instance “Golden Sea Restaurant Seafood & Bar”, e.g., from a restaurant sign.

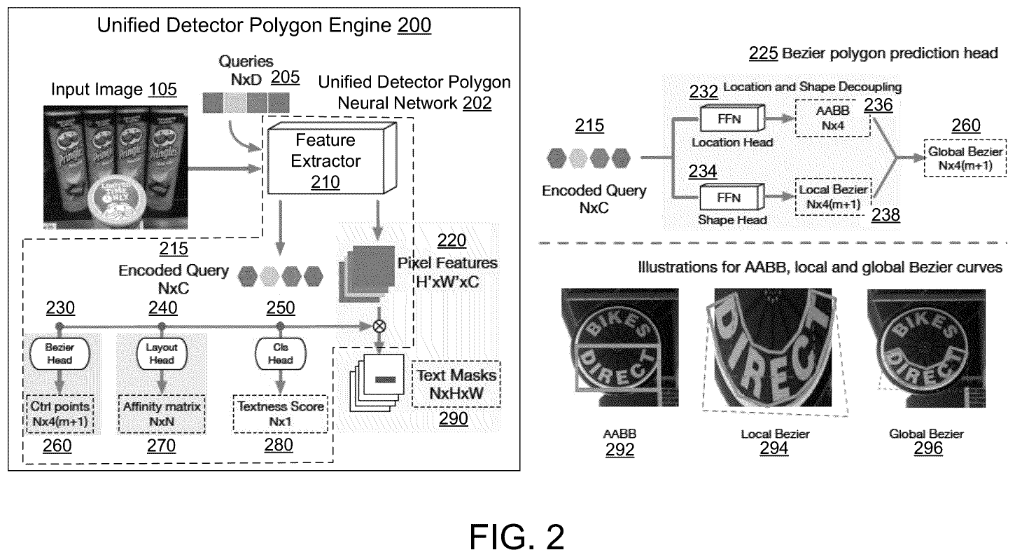

The system 100 can process the input image 105 using a unified detector polygon engine 110 to generate one or more polygon text boundaries corresponding to each text line included in the text instance and a paragraph grouping of the text lines, e.g., the output 120. In particular, the engine 105 can detect text lines of the text instance and can cluster the text lines into paragraph groups, e.g., using a generated affinity matrix. An example unified detector polygon engine 105 that includes a polygon prediction neural network configured to predict the coordinates of two Bezier polylines as the polygon text boundary will be described in more detail with respect to FIG. 2.

In some cases, the system 100 can use the output 120 of the unified detector polygon engine 110 to transform the input image 105, e.g., based on the generated polygon text boundaries. In particular, the system 100 can generate a text instance image 140 by preprocessing the original image with one or more transformations. As an example, the system 100 can crop a portion of the original image that corresponds with the location of the detected text instance and can rectify the original image to reorient the text instance. As a further example, the system 100 can apply a grayscale to the original image, can downsample the image, e.g., using a convolutional neural network, to generate a reduced dimension image, etc.

In the particular example depicted, the system 100 can crop and rectify 130 the input image 105 and additionally apply a grayscale to generate the text instance image 140. More specifically, the system 100 can crop the input image 105 to isolate the text instance and can use a bilinear interpolation mapping algorithm to transform the image to appear as though it were taken from a perpendicular viewpoint to generate the text instance image 140. In this case, the coordinates in the text instance space are the rectified coordinates, e.g., the system 100 has cropped and straightened the pixels included in and surrounding the “Golden Sea Restaurant Seafood & Bar” portion of the input image 105 to generate the text instance image 140.

In particular, the system can generate a bijection, e.g., a one-to-one mapping, from coordinates in the input image 105 space to coordinates in the text instance image 140 space, to rectify the image. As an example, the system 100 can use BezierAlign to rectify the image, as described in Yuliang Liu, Chunhua Shen, Lianwen Jin, Tong He, Peng Chen, Chongyu Liu, and Hao Chen. Abcnet v2: Adaptive bezier-curve network for real-time end-to-end text spotting. IEEE Transactions on Pattern Analysis and Machine Intelligence, 44 (11): 8048-8064, 2021. As another example, the system 100 can use a Thing Plate Spline method or a region of interest align method to rectify the image 105. As yet another example, the system 100 can use a piecewise linear transformation to rectify the image 105.

The system 100 can process the text instance image 140 using a line-to-character-to-word (L2C2 W) recognizer engine 150 to predict character classes and bounding boxes for each of the predicted characters in the text instance image 140, e.g., the output 160. Within the context of text detection, a bounding box is a box that encloses a detected text entity, e.g., a word or character. Axis-aligned bounding boxes are bounding boxes with coordinates defined on the x- and y-axes of an image.

In the case in which there are multiple text instances in the input image 105, the system can generate separate text instance images corresponding with each of the text instances in the input image 105 and can process each text instance image using the L2C2 W engine 150.

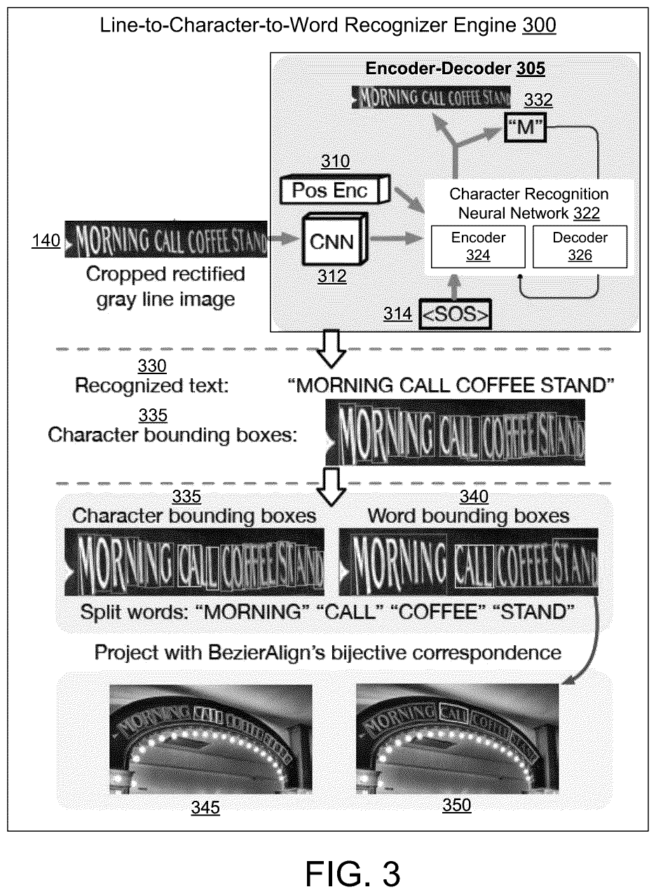

In particular, the L2C2 W engine 150 can be configured to predict character classes from a character set including printable characters, e.g., alphanumeric characters, punctuation characters, special characters, and a space character class. In some cases, the space character class can include other whitespace characters, e.g., tab and newline characters. An example L2C2 W engine 150 that includes an encoder-decoder neural network configured to encode the text instance image and autoregressively predict the character class and bounding box for each character in a sequence using the previous characters in the sequence will be described in more detail with respect to FIG. 3.

In addition, the system 100 can use the output 160 to detect word level text entities and generate word bounding boxes in the text instance image 140, e.g., using the bounding boxes for each of the characters. In particular, the system 100 can use the predicted space characters as a delimiter to identify groupings of characters as words. For example, the system 100 can group the bounding boxes predicted for each character, e.g., in-between each space character, as the word bounding box for the characters in the word.

The system 100 can then combine the output 120 of the unified detector polygon engine 110 and the line-to-character-to-word recognizer engine 150 to generate the output 170, which includes the hierarchical text representation 175 and respective layout masks 180 for each of the paragraph, line, word, and character-level entities represented in the hierarchical text representation 175. More specifically, the hierarchical text representation 175 can include any combination of the text lines and paragraphs detected by the unified detector polygon engine 110 and the characters and words detected by the line-to-character-to-word recognizer engine 150.

In this context, generating the hierarchical representation refers to populating a machine-readable encoded structure for each of the text entities included in the input image 105. In the particular example depicted, the hierarchical text representation 175 is a structured multi-level dictionary of the paragraph, word, text line, and character-level entities detected for each text instance within the input image 105. In this case, indents can be used to represent the hierarchy of the text entities included in the dictionary.

As depicted, the hierarchical text representation 175 generated for the input image 105 includes paragraph, text line, word, and character-level entities from the text instance “Golden Sea Restaurant Seafood & Bar”. In particular, the first paragraph includes one text line with two words, e.g., “Golden” and “Sea”, which both include the respective characters in the words; and the second paragraph includes two lines: the first line with two words, e.g., “Restaurant and Seafood”, which both include the respective characters in the words, and the second line with two words “&” and “Bar”, which both include the respective characters in the words. In this case the ampersand is treated as a separate word, e.g., since it is separated from other words by two space characters.

The system 100 can additionally generate one or more of paragraph, word, text line, and character-level masks that correspond to the detected text entities, e.g., the layout masks 180. As an example, the system 100 can overlay one or more of the layout masks 180 on the input image 105 to visualize the hierarchical text representation 175 on the input image 105.

In the particular example depicted, the text line and paragraph masks can be generated as an output of the unified detector polygon engine 110 and the word and character masks can be generated as the word and character bounding box output of the line-to-character-to-word recognizer engine 150. In the case that the masks were generated in the text instance image 140 space, the system 100 can use a bilinear interpolation mapping algorithm, e.g., BezierAlign, to transform the coordinates of the bounding boxes detected in the text instance image 140 space back to the input image 105 space.

For example, the output 170 of the joint text spotting and layout analysis system 100 can allow for high quality analysis of images that include text instances. As an example, the hierarchical text representation 175 can be used for a variety of downstream natural language processing tasks, such as semantic parsing, which involves converting a natural language utterance to a logical form or language graph, or for reasoning of text in a text-based visual-question answering (VQA) system in which a model is instructed to answer text questions based on images. As another example, the hierarchical text representation 175 can also be used for translating text in an image into another language or for indexing images for search engines. As yet another example, the hierarchical text representation 175 can also be used in video processing to enhance the inter-frame accuracy of blurred frames including text instances in videos.

FIG. 2 is an example implementation of a unified detector polygon engine that can detect a polygon text boundary for a text line of any arbitrary orientation using a unified detector polygon neural network. For example, the unified detector polygon engine 110 of the joint text spotting and layout analysis system 100 of FIG. 1 can be implemented as the unified detector polygon engine 200 of FIG. 2.

In the particular example depicted, the unified detector polygon engine 110 can receive an input image 105, e.g., an original image, and one or more input object queries 205. For example, the input object queries 205 can include learnable positional embeddings corresponding to different regions of the input image 105. In particular, the learnable positional embeddings can be used to represent potential object detections and the weights of the embeddings can be updated by processing the input image 105 and the input object queries 205. In particular, the engine 110 can process the input image 105 and the input object queries 205 using a unified detector polygon neural network 202 to generate text line and paragraph-level text masks 290.

In the particular example depicted, the unified detector polygon neural network 202 includes a feature extractor neural network 210 and one or more neural network heads, including a polygon detector prediction neural network 230. In this context, a neural network head refers to a specific neural network layer or set of neural network layers configured to generate a particular output from an intermediate input, e.g., the outputs 260, 270, and 280.

The feature extractor neural network 210 can have any appropriate neural network architecture that can be configured to process an input image 105 and the set of input object queries 205 to generate an encoded text representation of the input image 105. In this case, the encoded text representation includes a respective embedding corresponding to one or more regions in the input image 105, e.g., a set of encoded object queries 215, and the pixel features 220. In particular, the feature extractor neural network 210 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

More specifically, the feature extractor neural network 210 can enable information exchange between the input object queries 205 and the input image 105, e.g., by updating the learnable weights of the embeddings corresponding to different regions of the input image 105 based on the contents of the input image 105 within that region, to generate the extracted pixel features 220 and the set of encoded object queries 215.

As an example, the feature extractor neural network 210 can be implemented as a transformer-based feature extractor, e.g., the Max-DeepLab feature extractor, as described in Huiyu Wang, Yukun Zhu, Hartwig Adam, Alan Yuille, and Liang-Chich Chen. Max-deeplab: End-to-end panoptic segmentation with mask transformers. In Proceedings of the IEEE/CVF Conference on Computer Vision and Pattern Recognition, pages 5463-5474, 2021. In this case, the feature extractor neural network 210 includes an alternating sequence of convolutional neural network (CNN) and Dual-Path Transformer encoder blocks to encode both the input image 105 and the input object queries 205 in order to associate each encoded object query 215 with one object instance in the pixel features 220.

The engine 200 can then process the encoded object queries 215 to generate a variety of outputs. In particular, the unified detector polygon neural network 202 can be implemented with separate prediction heads to process the encoded object queries 215 to generate each of the outputs 260, 270, and 280, respectively. In this case, each of the heads can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

For example, the engine 200 can process the encoded object queries 215 using a layout head 240 to generate an affinity matrix 270 that defines the association of text lines to paragraphs. In some cases, the layout head 240 can include one or more transformer encoder blocks to extract additional layout features from the encoded object queries 215, e.g., features that were not extracted by the feature extractor neural network 210. In this case, the affinity matrix 270 can be generated by taking the inner product of the layout features extracted, e.g., using the transformer encoder blocks.

As another example, the engine 200 can process the encoded object queries 215 using a textness classification head 250 to generate the textness score 280, e.g., the likelihood of each encoded object query 215 being a text instance. In some cases, the textness score 280 can be a value that is compared to a threshold to determine a binary text instance classification.

As yet another example, the engine 200 can process the encoded object queries 215 using a polygon detector prediction neural network 230 to generate one or more control points of a polygon 260, e.g., the polygon that defines a boundary of the detected text instance in the input image 105. In the particular example depicted, the engine 200 can generate one or more control points 260 of a Bezier polygon, e.g., in this case, the polygon detector prediction neural network 230 is implemented using a Bezier polygon head 230. As another example, the engine 200 can generate control points of a polygon using a polygon detector prediction neural network 230 that has been trained to predict the points of a particular polygon, e.g., a rectangle, a trapezoid, a hexagon, etc.

A Bezier polygon is defined by two or more Bezier curves, e.g., polylines that are parameterized by a set of control points. For example, the Bezier head 230 can generate control points to parameterize each polygon text boundary as two Bezier curves of order m, e.g., one for a top and one for a bottom polyline of the polygon text boundary. In this case, each Bezier curve has m+1 control points, e.g., the Bezier head 230 can be configured to generate N*4 (m+1) control points 260, where N is the number of text lines and there are 2 (m+1) control points per text line, i.e., 4 (m+1) coordinates per text line.

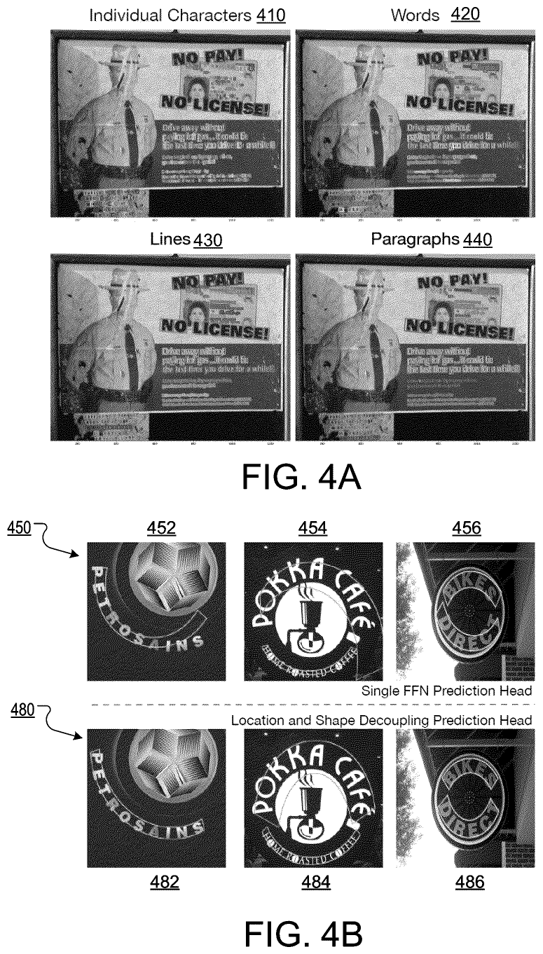

In the particular example depicted, the Bezier head 230 can include decoupled location 232 shape 234 heads. In this case, the Bezier head 230 can separate the task of predicting the location of an axis-aligned bounding box around the text line, e.g., with coordinates in the image space, and the shape, e.g., the control points, where the control points are predicted in the local coordinates of the predicted axis-aligned bounding box. In some cases, decoupling the location and shape allows for the detection of more accurate bounding boxes by decoupling bounding box location and shape prediction, e.g., as is described further with respect to FIG. 4B.

As an example, the location head 232 can generate values of the center, width, and height of a predicted axis-aligned bounding box for the text line 236, e.g., which can be represented as the axis-aligned bounding box 292. In particular, the location head 232 can generate the output 236, e.g., [x_{center,i}, y_{center,i}, wᵢ, hᵢ], for each text line. The shape head 234 can then generate the local Bezier control points 238, e.g., the N*4(m+1) Bezier control points whose coordinates are normalized in the local space of the axis-aligned bounding box 292 defined by the location head 232. In particular, the shape head 234 can generate the local control points 238, e.g., Bezier_{local,i}={(x\tilde{ }_{i,j}, y\tilde{ }_{i,j})}^{2(m+1}) per text line j, as the control points parameterizing the Bezier polygon in the local space of the axis-aligned bounding box 294.

In this case, the final output Bezier control points 260 are global Bezier control points, e.g., the global control points 260 in the image space 296, can be obtained by scaling and translating the local Bezier coordinates 238 generated by the shape head 234 using the axis-aligned bounding box 236 generated by the location head 232, e.g., Bezier_{global,i}={(x_{i,j}, y_{i,j})}^{2(m+1}) per text line j, where x_{i,j}=x\tilde{ }_{i,j}*wᵢ+x_{center,i} and y_{i,j}=y\tilde{ }_{i,j}*hᵢ+y_{center,i}.

The unified detector polygon neural network 202 can then compute the inner product of the outputs 260, 270, 280, and 220 to generate the text masks 290. More specifically, the unified detector polygon neural network 202 can compute the inner product of the control points 260 and the affinity matrix 270 with the pixel features 220 to generate the paragraph masks and can compute the inner product of the control points 260 and the textness score 280 with the pixel features 220 to generate the text line masks. In the case that the unified detector polygon engine 200 is implemented as part of the joint text spotting and layout analysis system 100, the system 100 can overlay the generated text masks 290 on the input image 105 to depict the text line-level and paragraph-level hierarchical text representation extracted by the unified detector polygon engine 200.

For example, the unified detector polygon neural network 202, e.g., the feature extractor neural network 210, the polygon detector prediction neural network 230, e.g., the Bezier head 230 including the decoupled location head 232 and the shape head 234, the layout head 240, and the textness classification head 250, can be trained using supervision. In particular, the unified detector polygon neural network 202 can be trained on a set of training examples, e.g., where each training example corresponds to a respective ground-truth polygon text boundary and includes a training model input and a training model output. For example, the training model input can include a set of training input images that include at least one text instance, and the training model output can include the ground-truth control points of the polygon text boundary in the training input image space.

In some cases, the system 100 of FIG. 1 can train the unified detector polygon neural network 202 on the set of training examples to optimize an objective function. In other cases, a different system can train the unified detector polygon neural network 202. The objective function can measure, e.g., for each training example, a discrepancy between: (i) the ground-truth control points in the training input image space and the (ii) predicted control points in the training input image space generated by the unified detector polygon neural network 202.

The objective function can measure the discrepancy between ground-truth and predicted control points in any appropriate way, e.g., using a cross-entropy loss or a mean squared error loss. In some cases, the objective function can include a sum of one or more losses computed between the ground-truth and predicted control points in the text instance image 140 space and the input image 105 space. In this case, the sum of the one or more losses can be a weighted sum, e.g., each loss can be assigned a relative importance weight.

For example, the objective function can include an image space polygon loss that characterizes the overlap of the predicted polygon text boundary and the ground truth polygon text boundary, e.g., an IoU loss, in the input image 105 space. As another example, the objective function can include an image space location loss that characterizes the accuracy of the control point coordinates in the input image 105 space. As yet another example, the objective function can include a local axis-aligned bounding box space polygon loss that characterizes the accuracy of the control points predicted in the local axis-aligned bounding box 292 space.

In addition, the objective function can include loss terms that pertain to the paragraph and text line grouping of the text instance detected in the polygon text boundary. In this case, the training examples can additionally include ground-truth text and paragraph annotations as a training input. For example, the objective function can include a text loss that characterizes an overlap of the predicted text line mask, e.g., from the inner product of the outputs 260 and 280, with a ground truth text line mask in the input image 105 space. As another example, the objective function can include a paragraph layout analysis loss that characterizes whether the affinity matrix 270 generated by the layout head 240 maps the text line to the correct paragraph.

The system 100 or another system can train the unified detector polygon neural network 202 at each of a number of training iterations until a training termination criterion is met. For example, the system 100 or the other system can train the unified detector polygon neural network by calculating and backpropagating gradients of the objective function to update parameter values of the network 202, e.g., using the update rule of any appropriate gradient descent optimization algorithm, e.g., RMSprop or Adam.

FIG. 3 is an example implementation of a line-to-character-to-word recognizer (L2C2 W) engine that can detect characters and words using an encoder-decoder neural network. For example, the line-to-character-to-word recognizer engine 150 of the joint text spotting and layout analysis system 100 of FIG. 1 can be implemented as the line-to-character-to-word recognizer engine 300 of FIG. 3.

As discussed with respect to FIG. 1, the L2C2 W engine 300 can receive a cropped and rectified text instance image, e.g., the text instance image 140. In some cases, the text instance image 140 can be a grayscale image. The L2C2 W engine 300 can process the text instance image 140 using an encoder-decoder neural network 305 that includes an image encoder, e.g., 310 and 312, and a character recognition neural network 322, as will be described in more detail below.

The encoder-decoder neural network 305 can have any appropriate neural network composed of one or more encoder and one or more decoder blocks that can be configured to process a text instance image 140 to generate the recognized text 330 and character bounding boxes 335. In particular, the encoder-decoder neural network 305 can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers).

In some cases, the encoder-decoder neural network 305 is a generative model, e.g., a generative-adversarial network or an autoregressive language processing network. As an example, the encoder-decoder neural network 305 can have a recurrent neural network architecture that is configured to sequentially process the contents of the text instance image 140 and trained to perform next element prediction, e.g., to define a likelihood score distribution over a set of next elements. More specifically, the encoder-decoder neural network 305 can include one or more of a recurrent neural network (RNN), long short-term memory (LSTM), or gated-recurrent unit (GRU). As another example, the encoder-decoder neural network 305 can be an encoder-decoder transformer.

In particular, the encoder-decoder neural network 305 can be a language processing neural network. A language processing neural network is an auto-regressive network that is configured to sequentially process the contents of an input and trained to perform next element prediction. For example, the encoder-decoder neural network 305 can be referred to as an auto-regressive neural network when the neural network auto-regressively generates an output sequence of tokens. More specifically, the auto-regressively generated output is created by generating each particular token in the output sequence conditioned on a current input sequence that includes any tokens that precede the particular token in the output sequence, i.e., the tokens that have already been generated for any previous positions in the output sequence that precede the particular position of the particular token.

For example, the encoder-decoder neural network 305 can be an auto-regressive Transformer-based neural network that includes (i) a plurality of attention blocks that each apply a self-attention operation and (ii) an output subnetwork that processes an output of the last attention block to generate the score distribution.

In this example, the neural network can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv: 2203.15556, 2022; J. W. Rac, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glacse, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d′Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv: 1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neclakantan, Pranav Shyam, Girish Sastry, Amanda Askell, et al. Language models are few-shot learners. arXiv preprint arXiv: 2005.14165, 2020.

Generally, to apply the self-attention operation, each attention block uses one or more attention heads. Each attention head generates a set of queries, a set of keys, and a set of values, and then applies any of a variety of variants of query-key-value (QKV) attention, e.g., a dot product attention function or a scaled dot product attention function, using the queries, keys, and values to generate an output. Each query, key, value can be a vector that includes one or more vector elements. When there are multiple attention heads, the attention block then combines the outputs of the multiple attention heads, e.g., by concatenating the outputs and, optionally, processing the concatenated outputs through a linear layer.

In the particular example depicted, the encoder-decoder neural network 305 includes an image encoder, e.g., convolutional neural network (CNN) 312, and a character recognition neural network 322 that includes an encoder neural network 324 and a decoder neural network 326. In this case, the encoder 324 and decoder 326 neural networks can have any appropriate number of neural network layers (e.g., 1 layer, 5 layers, or 10 layers) of any appropriate type (e.g., fully-connected layers, attention layers, convolutional layers, etc.) connected in any appropriate configuration (e.g., as a linear sequence of layers, or as a directed graph of layers). For example, the encoder 324 and the decoder 326 neural networks can be implemented as a transformer encoder and a transformer decoder, respectively.

In particular, the image encoder, e.g., the CNN 312, can process the text instance image 140 to generate one or more embeddings corresponding to a number of regions in the image. More specifically, the CNN 312 can encode the pixels of the text instance image 140 into encoded features of a text representation. As an example, the CNN 312 can be implemented as a MobileNetV2 network. In some cases, the CNN 312 can also be used to reduce the height, the width, or both dimensions using strided convolutions.

In this case, the transformer encoder 324 of the character recognition neural network 322 further encodes the encoded features to generate a contextualized encoded sequence, e.g., using a positional encoding 310 to assign a unique vector to each position in the input sequence. As an example, the positional encoding 310 can be a sinusoidal positional encoding, e.g., a positional encoding that uses sine and cosine functions of different frequencies to assign the unique vector to each position in the input sequence.

In particular, the character recognition neural network 322 can apply the positional encoding 310 to the one or more embeddings generated by the CNN 312 using the transformer encoder 324 to generate a contextualized encoded sequence. The character recognition neural network 322 can then process the contextualized encoded sequence using the transformer decoder 326. More specifically, the character recognition neural network 322 can generate an encoded hidden representation and can autoregressively decode the encoded hidden representation, e.g., to produce a probability distribution over the next token conditioned on the generated previous tokens 314 that can be used to generate the predicted character class 332.

More specifically, the transformer decoder 326 can include an attention neural network, e.g., a self-attention block, that is configured to process the contextualized encoded sequence and the respective predicted character class for each character that precedes the character in the sequence of characters to generate a hidden representation feature for each character being predicted. In this case, the transformer decoder 326 can further include a character prediction neural network that is configured to process the hidden representation feature for each character to predict the next character class and a bounding box neural network that is configured to process the hidden representation feature for each character to predict the bounding box coordinates for the character.

In particular, the character prediction neural network can predict character classes from a character set including printable characters, e.g., alphanumeric characters, punctuation characters, special characters, and a space character class. In some cases, the space character class can include other whitespace characters, e.g., tab and newline characters.

As an example, the transformer decoder 324 can be implemented as a auto-regressive transformer decoder to generate the predicted next character class for each character. In this case, the vanilla transformer decoder 324 can be augmented with an additional bounding box prediction head to generate the coordinates of the character bounding box for each predicted character class. In particular, the bounding box neural network can process the hidden representation feature for each character to generate a number of bounding box coordinates within the text instance image 140 space as the character bounding box, e.g., the bounding box that contains the predicted character within the text instance image 140. For example, the bounding box neural network can generate a four-dimensional vector representing the top-left and bottom-right coordinates of the character bounding box, e.g., normalized by the height of each text line. In some cases, the bounding box neural network can be implemented as a two-layer feedforward network.

As depicted, the character recognition neural network 322 can autoregressively process each hidden representation feature to generate the recognized text 330 that includes the sequence of predicted character classes and the character bounding boxes 335 for each predicted character in the sequence.

The L2C2 W recognizer engine 300 can then group the predicted characters and character bounding boxes into words and corresponding word bounding boxes 340. In particular, the engine 300 can use each space character as a delimiter to identify word boundaries, e.g., where the definition of a word is a sequence of printable characters either between two space characters or between a space character and the start and end of the character sequence. More specifically, the engine 300 can group together character bounding boxes 335 based on the defined word boundaries, e.g., by identifying the minimum area axis-aligned bounding box that subsumes the bounding boxes for each character in the word to generate the word bounding boxes 340.

Since the L2C2 W engine 300 operates in the space of the text instance image 140, e.g., the cropped and rectified image space, by processing the text instance image 140, the generated coordinates of the word 340 and character 335 bounding boxes are defined in the local coordinates of the text instance image 140. For example, the engine 300 can project the generated coordinates of the word 340 and character 335 bounding boxes back into the input image 105 space, e.g., using a bilinear interpolation mapping algorithm, e.g., BezierAlign, to generate a bijection from coordinates in the text instance image 140 space to coordinates in the input image space. In particular, the transformed bounding boxes in the input image space can be used as individual character 345 and word 350 masks, e.g., that can be overlayed with the input image 105.

In some cases, the system 100 of FIG. 1 or another system can train the encoder-decoder neural network 305 on a set of training examples, e.g., text lines, to optimize an objective function. The objective function can measure a weighted sum of a character classification loss, e.g., to measure the accuracy of the predicted characters with respect to ground truth characters and a character localization loss, e.g., to measure the accuracy of the predicted character bounding boxes with respect to ground truth bounding box annotations, for each text line. For example, the system 100 can use a cross-entropy loss for character classification and an L1 loss for character localization.

In particular, the system 100 or another system can train the encoder-decoder neural network 305 using a training data set that includes both real and synthetic images that include at least one text instance. In the case that one or more of the real or synthetic images do not include annotated character bounding boxes, the system 100 or the other system can apply the localization loss only when ground truth bounding box annotations are available. For example, the encoder-decoder neural network 305 can be trained using an objective function for each text line formulated as:

$${L}_{r} ec = \frac{1}{T} {\sum }_{t = 1}^{T} {L}_{CE} ( {y}_{t} , {\hat{y}}_{t} ) + \frac{{λ}_{4} {\sum }_{t = 1}^{T} {α}_{t} {L}_{{L}_{1}} ( {box}_{t} , )}{{\sum }_{t = 1}^{T} {α}_{t} + ε}$$

where T is the number of characters, L_{CE} is the character classification cross-entropy loss, λ₄ is the weight for the localization loss, αₜ is an indicator for whether the given text line has a defined ground truth character bounding box, and ε is a small positive number to avoid a zero denominator. In this case, the summation and average can be computed on a batch level, e.g., to balance the loss between long and short text lines.

FIGS. 4A-4B illustrate example results from the example joint text spotting and layout analysis system 100 of FIG. 1. In particular, FIG. 4A depicts example masks generated from the hierarchical text representation output of the system and FIG. 4B demonstrates how the system can detect more accurate polygon text boundaries by decoupling the prediction of bounding box location and shape.

FIG. 4A depicts a rendering of the respective character 410, word 420, line 430, and paragraph 440 masks generated using the hierarchical text representation output of the system 100 of FIG. 1 for an example image. For example, the line-to-character-to-word recognizer engine 300 of FIG. 3 can generate the individual character masks 410 and word masks 420 and the unified detector polygon engine 200 can generate the text line 430 and paragraph 440 masks. In particular, the results demonstrate how the joint text spotting and layout analysis system 100 can detect paragraphs, lines, words, and characters in an image with high fidelity.

FIG. 4B demonstrates how the system can detect more accurate polygon text boundaries by decoupling bounding box location and shape prediction, e.g., using the decoupled location head 232 and shaped head 234 of the polygon detector prediction neural network of FIG. 2 to predict the control points of the polygon text boundary.

In some cases, polygon text boundary location learning can dominate polygon text boundary shape prediction. Decoupling the location and shape prediction separates and balances the tasks resulting in better performance on more complex geometric layouts. In particular, the contrast between panel 450 and panel 480 demonstrates how decoupling location and shape prediction can generate more accurate polygon text boundaries that better fit text with a circular orientation than a single prediction head trained to generate both the location and the shape of the control points of the polygon text boundary.

More specifically, the single head predicts polygon text boundaries that do not fully align with the geometric orientation of the circular text, e.g., as depicted in 452, 454, and 456, respectively. In contrast, the decoupled location and shape heads generate polygon text boundaries that fully align with the geometric orientation of the circular text, e.g., as depicted in 482, 484, and 486.

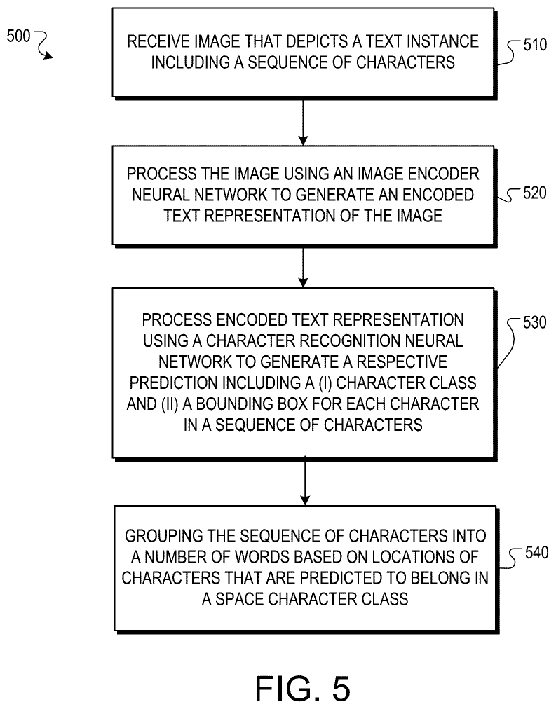

FIG. 5 is a flow diagram of an example process for detecting word and character-level entities. For convenience, the process 500 will be described as being performed by a system of one or more computers located in one or more locations. For example, a joint text spotting and layout analysis system, e.g., the joint text spotting and layout analysis system 100 of FIG. 1, appropriately programmed in accordance with this specification, can perform the process 500.

The system can receive an image that depicts a text instance including a sequence of characters (step 510). In this context, a text instance is a text-containing element of an image. Text can appear in one or more regions of an image. As an example, the text instance can be a brand name, a slogan, text overlayed on an image, etc. In some cases, the image that depicts the text instance is generated by preprocessing an original image with one or more transformations from an original input image space to a text instance space. In other cases, the system can receive an image that was not generated with any preprocessing.

For example, a preprocessing transformation can include cropping a portion of the original image that corresponds with the location of the text instance region in the original image. As another example, a preprocessing transformation can include rectifying the original image to reorient the text instance, e.g., to a defined coordinate system. As yet another example, a preprocessing transformation can include applying a grayscale to the original image. As a further example, a preprocessing transformation can include downsampling the image, e.g., the system can process the image using a convolutional neural network to generate a reduced-dimension image.

In some cases, the system can crop and rectify the original image using a bilinear interpolation mapping algorithm, e.g., the BezierAlign algorithm. In this case, the system can generate a bijection, e.g., a two-way mapping, from coordinates in the original input image space to coordinates in the text instance space.

The system can process the image using an image encoder neural network to generate an encoded text representation of the image (step 520). In particular, the system can generate respective embeddings corresponding to each of a number of regions in the image. An example for generating embeddings and identifying one or more encoded text representations of the image using a unified detector polygon neural network will be described in more detail with respect to FIG. 7.

The system can process the encoded text representation using a character recognition neural network to generate a respective prediction including a character class and a bounding box for each character in a sequence of characters (step 530). In this case, a bounding box is a box that encloses a detected character. More specifically, the system can generate a predicted character class selected from a set that includes printable character classes and a delimiter character class, e.g., a space, comma, slash, etc., and can generate a bounding box that contains the character within the image using separate prediction heads.

For example, the character recognition neural network can be an encoder-decoder neural network. In particular, the character recognition neural network can include an encoder neural network that is configured to encode the characters in the text representation into a contextualized encoded sequence and a decoder neural network including an attention neural network, a character prediction neural network, and a bounding box neural network. In this case, the attention neural network can be configured to process the contextualized encoded sequence and the respective predicted character class for each character that precedes the character in the sequence of characters to predict the next character class, e.g., the attention neural network can autoregressively generate a hidden representation feature for each character. Furthermore, in this case, the system can process the hidden representation feature for each character to predict the next character class, e.g., using the character prediction neural network, and can process the hidden representation feature to generate character bounding box coordinates.

In particular, the system can generate the bounding box coordinates within the text instance image space, e.g., the system can generate coordinates within the text instance image space that correspond to the character bounding box that contains the predicted character within the text instance. For example, the system can generate the bounding box coordinates within the text instance image space and can scale the coordinates back into the original image space, e.g., by normalizing by text instance height, and by projecting back to the original image space using a bilinear interpolation mapping algorithm, e.g., BezierAlign. In this case, the system can generate a bijection, e.g., a two-way mapping, from coordinates in the text instance space to coordinates in the original input image space.

The system can group the sequence of characters into a number of words based on locations of characters that are predicted to belong in a space character class (step 540). For example, the system can generate coordinates of a bounding box for each word by combining the respective bounding box coordinates of the one or more characters grouped into the word. In other cases, the system can use a delimiter character class, e.g., a comma, slash, etc., to group one or more characters into words.

The image encoder neural network and the character recognition neural network can have been trained using any appropriate machine learning training technique using supervision, e.g., the model can be trained by calculating and backpropagating gradients of an objective function to update parameter values of the model, e.g., using the update rule of any appropriate gradient descent optimization algorithm, e.g., RMSprop or Adam. As an example, the image encoder neural network and character recognition neural network can have been jointly trained on a training data set, e.g., using supervision with a character classification loss. As another example, the image encoder neural network and character recognition neural network can have been jointly trained using supervision with an additional character localization loss, e.g., for a subset of the training data set for which ground-truth bounding box annotations are available.

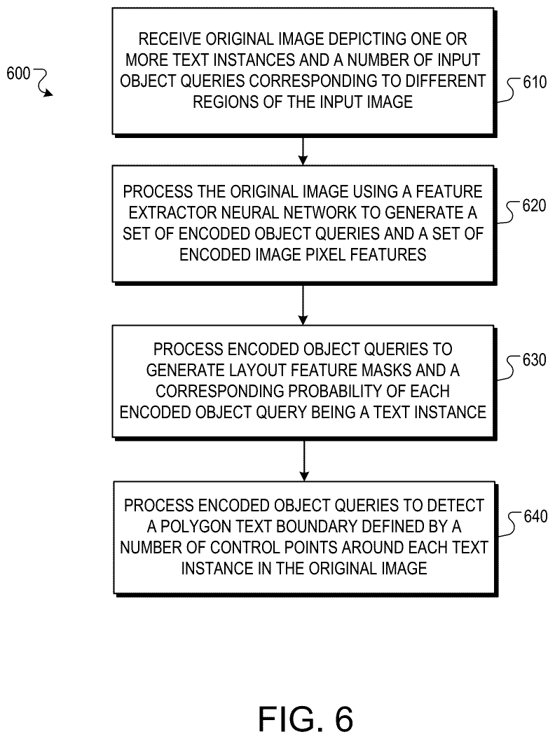

FIG. 6 is a flow diagram of an example process for detecting a polygon text boundary around a text instance. For convenience, the process 600 will be described as being performed by a system of one or more computers located in one or more locations. For example, a joint text spotting and layout analysis system, e.g., the joint text spotting and layout analysis system 100 of FIG. 1, appropriately programmed in accordance with this specification, can perform the process 600. For example, the system 100 can perform the process 600 as part of step 520 in FIG. 5.

The system can receive an original image depicting one or more text instances and a number of input object queries corresponding to different regions of the image (step 610). In particular, the input object queries can include learnable positional embeddings corresponding to different regions of the image.

The system can process the original image using a feature extractor neural network to generate a set of encoded object queries and a set of encoded image pixel features (step 620). In particular, the encoded object queries can include an embedding corresponding to each region in the original image. For example, the system can process the image and a set of learnable object queries similar to a DEtection TRansformer (DETR), e.g., as described in Maoyuan Ye, Jing Zhang, Shanshan Zhao, Juhua Liu, Bo Du, and Dacheng Tao. Dptext-detr: Towards better scene text, detection with dynamic points in transformer. arXiv preprint arXiv: 2207.04491, 2022, and can enable information exchange between the extracted pixel features and the set of encoded object queries. As an example, the feature extractor neural network can be implemented as a combination convolutional and transformer neural network, e.g., the MaX-DeepLab feature extractor.

The system can process the encoded object queries to generate layout feature masks and a corresponding probability of each encoded object query being a text instance (step 630). More specifically, the system can identify the encoded image pixel features corresponding to regions that include text instances, e.g., as the one or more encoded text representations in step 520 of FIG. 5, by processing each encoded object query that is associated with each text instance in the image.

In particular, the system can process the encoded object queries with a layout head to generate a number of layout feature masks that correspond with each encoded object query, and can process the encoded object queries with a textness head to generate a number of classification scores denoting a probability of each generated feature mask associated with each encoded object query being a text instance. The system can then compute an inner product of the generate feature masks from the layout head to produce an affinity matrix of feature similarity. As an example, the system can generate a paragraph grouping representation for each encoded object query that is determined to be a text instance, e.g., based on the classification score, using the affinity matrix.

The system can process the encoded object queries using a polygon detector prediction neural network configured to detect a polygon text boundary defined by a number of control points around each text instance in the original image (step 640). For example, the polygon detector prediction neural network can include a location head and a shape head, e.g., to decouple the prediction of text location and shape. In this case, the location head can be configured to generate a number of coordinates defining an axis-aligned bounding box, e.g., a bounding box with coordinates defined on x- and y-axes. for each text instance in the original image space, and the shape head can be configured to generate a number of control points defining a polygon within a local bounding box image space, e.g., as defined by the axis-aligned bounding box. As an example, the shape head can be implemented as a Bezier polygon prediction head that can predict 4(m+1) control points corresponding to two Bezier polylines of order m that character polylines that constitute the polygon text boundary. In some cases, the polygon detector prediction neural network can be configured to scale and translate the polygon defined by the control points within the local bounding box space back into the original image space using the coordinates of the axis-aligned bounding box.

As an example, the unified detector polygon neural network can have been trained using any appropriate machine learning training technique, e.g., the model can be trained by calculating and backpropagating gradients of an objective function to update parameter values of the model, e.g., using the update rule of any appropriate gradient descent optimization algorithm, e.g., RMSprop or Adam. In this case, the objective function can be a loss function, in particular, the unified detector polygon neural network can have been trained to minimize a loss function that includes a weighted sum of one or more losses.

For example, the loss function can include a text loss that characterizes an overlap of the predicted text mask from the textness head with a ground truth text mask in the original image space for each predicted text instance. As another example, the loss function can include a paragraph layout analysis loss that characterizes whether the affinity matrix generated by the layout head maps each text line in the text instance to a correct paragraph. As yet another example, the loss function can include an original image space polygon loss that characterizes the overlap of the polygon text boundary detected by the polygon detector prediction neural network with a respective ground truth polygon in the original image space. As a further example, the loss function can include an original image space location loss that characterizes an accuracy of the plurality of coordinates predicted by the location head that defines the axis-aligned bounding box in the original image space. As yet a further example, the loss function can include a local axis-aligned bounding box space polygon loss that characterizes the accuracy of the plurality of polygon control points predicted by the shape head in the local axis-aligned bounding box.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method performed by one or more computers, the method comprising:
receiving an image that depicts a text instance comprising a sequence of characters;
processing the image using an image encoder neural network to generate an encoded text representation of the image that comprises a respective embedding corresponding to each of a plurality of regions in the image;
processing the encoded text representation using a character recognition neural network to generate a respective prediction for each character in a sequence of characters that are predicted to be depicted in the text instance, the respective prediction comprising:
a respective character class to which the predicted character belongs, the respective character class selected from a set that includes printable character classes and a space character class; and
a bounding box that contains the character within the image; and
grouping the sequence of characters into a plurality of words based on locations of characters that are predicted to belong to the space character class.

2. The method of claim 1, wherein the image that depicts a text instance is generated by preprocessing an original image with one or more transformations from an original input image space to a text instance space, the one or more transformations comprising one or more of:
cropping a portion of the original image that corresponds with a location of the text instance region in the original image;
rectifying the original image to reorient the text instance;
applying a grayscale to the original image; or
processing the original image with a convolutional neural network to generate a reduced-dimension image.

3. The method of claim 2, wherein the original image is cropped and rectified using a bilinear interpolation mapping algorithm.

4. The method of claim 3, wherein the bilinear interpolation mapping algorithm is a BezierAlign algorithm that generates a bijection from coordinates in the original input image space to coordinates in the text instance space.

5. The method of claim 1, wherein the character recognition neural network comprises:
an encoder neural network that is configured to encode the plurality of characters in the text representation into a contextualized encoded sequence;
a decoder neural network comprising:
an attention neural network that is configured to process the contextualized encoded sequence and, for each character that precedes the character in the sequence of characters, the respective predicted character class for the character to generate a hidden representation feature for each character;
a character prediction neural network that is configured to, for each character, process the hidden representation feature to predict the next character class; and
a bounding box neural network that is configured to, for each character, process the hidden representation feature to generate a plurality of bounding box coordinates within the text instance image space that correspond to the character bounding box that contains the predicted character within the text instance.

6. The method of claim 5, wherein generating the plurality of bounding box coordinates for each predicted character yields bounding box coordinates in a text instance space and wherein the method further comprises scaling the coordinates back into the image space, the scaling comprising:
normalizing by text instance height; and
projecting back to the image space using a bilinear interpolation mapping algorithm.

7. The method of claim 6, wherein the bilinear interpolation mapping algorithm that generates a bijection from coordinates in the text instance space to coordinates in the original input image space is a BezierAlign algorithm.

8. The method of claim 5, further comprising:
for each word, generating coordinates of a bounding box for the word by combining the respective bounding box coordinates of the one or more characters grouped into the word.

9. The method of claim 5, wherein the image encoder neural network and character recognition neural network have been trained on a training data set using supervision with a character classification loss.

10. The method of claim 9, wherein the image encoder neural network and character recognition neural network have been trained using supervision with an additional character localization loss for a subset of the training data set for which ground-truth bounding box annotations are available.

11. A method performed by one or more computers, the method comprising:
receiving an original image depicting one or more text instances and a plurality of input object queries comprising learnable positional embeddings corresponding to different regions of the original image; and
processing the original image and the plurality of input object queries using a unified detector polygon neural network, wherein the unified detector polygon neural network comprises:
a feature extractor neural network configured to generate a set of encoded object queries, wherein the encoded object queries comprise an embedding corresponding to each region in the original image, and a set of encoded image pixel features; and
a polygon detector prediction neural network configured to process the encoded object queries to detect a polygon text boundary defined by a plurality of control points around each of one or more text instances in the original image.

12. The method of claim 11, wherein the polygon detector prediction neural network comprises:
a location head that is configured to generate a plurality of coordinates defining an axis-aligned bounding box for each text instance in the original image space;
a shape head that is configured to generate a plurality of control points defining a polygon within a local bounding box image space as defined by the axis-aligned bounding box; and
wherein the polygon detector prediction neural network is configured to scale and translate the polygon defined by the control points within the local bounding box space back into the original image space using the coordinates of the axis-aligned bounding box.

13. The method of claim 12, wherein the shape head comprises a Bezier polygon prediction head that predicts 4 (m+1) control points corresponding to two Bezier polylines of order m that characterize polylines that constitute the polygon text boundary.

14. The method of claim 11, further comprising processing the encoded object queries with the polygon detector prediction neural network, wherein processing the encoded object queries with the polygon detector prediction neural network further comprises:
processing the encoded object queries with a layout head to generate a plurality of layout feature masks that correspond with each encoded object query;
processing the encoded object queries with a textness head to generate a plurality of classification scores denoting a probability of each generated feature mask associated with each encoded object query being a text instance;
computing an inner product of the generated feature masks from the layout head to produce an affinity matrix of feature similarity; and
generating a paragraph grouping representation for each encoded object query that is determined to be a text instance from the affinity matrix.

15. The method of claim 14, wherein the unified detector polygon neural network has been trained to minimize a loss function that comprises a weighted sum of one or more losses, wherein the losses comprise, for each predicted text instance:
a text loss that characterizes an overlap of the predicted text mask from the textness head with a ground truth text mask in the original image space;
a paragraph layout analysis loss that characterizes whether the affinity matrix generated by the layout head maps each text line in the text instance to a correct paragraph;
an original image space polygon loss that characterizes the overlap of the polygon text boundary detected by the polygon detector prediction neural network with a respective ground truth polygon in the original image space;
an original image space location loss that characterizes an accuracy of the plurality of coordinates predicted by the location head that defines the axis-aligned bounding box in the original image space; and
a local axis-aligned bounding box space polygon loss that characterizes the accuracy of the plurality of polygon control points predicted by the shape head in the local axis-aligned bounding box space.

16. A system comprising one or more computers and one or more storage devices storing instructions that are operable, when executed by the one or more computers, to cause the one or more computers to perform operations comprising:
receiving an image that depicts a text instance comprising a sequence of characters;
processing the image using an image encoder neural network to generate an encoded text representation of the image that comprises a respective embedding corresponding to each of a plurality of regions in the image;
processing the encoded text representation using a character recognition neural network to generate a respective prediction for each character in a sequence of characters that are predicted to be depicted in the text instance, the respective prediction comprising:
a respective character class to which the predicted character belongs, the respective character class selected from a set that includes printable character classes and a space character class; and
a bounding box that contains the character within the image; and
grouping the sequence of characters into a plurality of words based on locations of characters that are predicted to belong to the space character class.

17. A computer storage medium encoded with a computer program, the program comprising instructions that are operable, when executed by data processing apparatus, to cause the data processing apparatus to perform operations comprising:
receiving an image that depicts a text instance comprising a sequence of characters;
processing the image using an image encoder neural network to generate an encoded text representation of the image that comprises a respective embedding corresponding to each of a plurality of regions in the image;
processing the encoded text representation using a character recognition neural network to generate a respective prediction for each character in a sequence of characters that are predicted to be depicted in the text instance, the respective prediction comprising:
a respective character class to which the predicted character belongs, the respective character class selected from a set that includes printable character classes and a space character class; and
a bounding box that contains the character within the image; and
grouping the sequence of characters into a plurality of words based on locations of characters that are predicted to belong to the space character class.

18. A system comprising one or more computers and one or more storage devices storing instructions that are operable, when executed by the one or more computers, to cause the one or more computers to perform operations comprising:
receiving an original image depicting one or more text instances and a plurality of input object queries comprising learnable positional embeddings corresponding to different regions of the original image; and
processing the original image and the plurality of input object queries using a unified detector polygon neural network, wherein the unified detector polygon neural network comprises:
a feature extractor neural network configured to generate a set of encoded object queries, wherein the encoded object queries comprise an embedding corresponding to each region in the original image, and a set of encoded image pixel features; and
a polygon detector prediction neural network configured to process the encoded object queries to detect a polygon text boundary defined by a plurality of control points around each of one or more text instances in the original image.

19. A computer storage medium encoded with a computer program, the program comprising instructions that are operable, when executed by data processing apparatus, to cause the data processing apparatus to perform operations comprising:
receiving an original image depicting one or more text instances and a plurality of input object queries comprising learnable positional embeddings corresponding to different regions of the original image; and
processing the original image and the plurality of input object queries using a unified detector polygon neural network, wherein the unified detector polygon neural network comprises:
a feature extractor neural network configured to generate a set of encoded object queries, wherein the encoded object queries comprise an embedding corresponding to each region in the original image, and a set of encoded image pixel features; and
a polygon detector prediction neural network configured to process the encoded object queries to detect a polygon text boundary defined by a plurality of control points around each of one or more text instances in the original image.
